(19) United States
(12) Patent Application Publication
(10) Pub. No.: US 2015/0106104 A1
(43) Pub. Date: Apr. 16, 2015

(54) DISPLAY DEVICE AND CONTROL METHOD THEREOF

(71) Applicant: SAMSUNG ELECTRONICS CO., LTD., Suwon-si (KR)

(72) Inventors: Chang-won SON, Daegu (KR); Young-hoon CHO, Suwon (KR); Byeong-cheol HYEON, Suwon (KR)

(73) Assignee: SAMSUNG ELECTRONICS CO., LTD., Suwon-si (KR)

(21) Appl. No.: 14/310,726

(22) Filed: Jun. 20, 2014

(30) Foreign Application Priority Data
Oct. 10, 2013 (KR) 10-2013-0120457

(51) Int. Cl. G10L 13/00; G08B 3/10

(52) U.S. Cl. CPC G10L 13/00; G08B 3/10; G08C 2201/50
USPC 704/270

(57) ABSTRACT

Disclosed is a display device including: a signal receiver which receives a remote control signal from a remote controller that includes a plurality of input buttons; a storage which stores therein voice information corresponding to the plurality of input buttons of the remote controller; a voice output which outputs the voice information; and a voice output controller which identifies one of the plurality of input buttons that has been selected from the input buttons, based on the received remote control signal, and controls the voice output to output the stored voice information corresponding to the identified input button.

### CROSS-REFERENCE TO RELATED APPLICATIONS

This application claims priority from Korean Patent Application No. 10-2013-0120457, filed on Oct. 10, 2013 in the Korean Intellectual Property Office, the disclosure of which is incorporated herein by reference.

### BACKGROUND

1. Field

Apparatuses and methods consistent with the exemplary embodiments relate to a display device and a control method thereof, and more particularly, to a display device and a control method thereof which stores voice information corresponding to a plurality of input buttons of a remote controller, and if the remote controller transmits a remote control signal to the display device, outputs corresponding audible voice information to notify a user.

2. Description of the Related Art

In connection with the embodiments set forth herein, a display device is designed to perform operations as desired by a user with manipulation of a remote controller. However, a user who is visually handicapped may not be able to see a remote controller and, thus, may not know what operation the display device performs when a user has pushed a particular button of the remote controller.

If voice information of buttons of the remote controller is provided whenever the buttons are pushed, it may be helpful, but definitions of operations and voice information provided would be necessary. Further, if voice information is provided in a situation where the remote controller and the display device are already provided, a user would need to purchase a new remote controller. As the remote controller performs operations wirelessly, it should have its battery exchanged or charged, and this may cause inconvenience.

Therefore, there is a need to provide a display device which may provide voice information of pushed buttons of the remote controller and may perform operations when the buttons of the remote controller are pushed for a visually handicapped or impaired user.

### SUMMARY

Accordingly, one or more exemplary embodiments provide a display device and a control method thereof which stores voice information corresponding to a plurality of input buttons of a remote controller, identifies one of the plurality of input buttons that has been selected from the input buttons on the basis of a remote control signal received by the display device, and outputs voice information stored in the display device corresponding to the identified input button to thereby enable a visually handicapped user to freely and conveniently manipulate the display device with the remote controller.

The foregoing and/or other aspects may be achieved by providing a display device including: a signal receiver which receives a remote control signal from a remote controller where the remote controller includes a plurality of input buttons; a storage which stores therein voice information corresponding to the plurality of input buttons of the remote controller; a voice output which outputs the voice information; and a voice output controller which identifies one of the plurality of input buttons that has been selected from the input buttons as an identified input button based on the remote control signal that has been received, and controls the voice output to output the voice information that has been stored corresponding to the identified input button

The voice information may include at least one of name information, function information and operation information of the plurality of input buttons of the remote controller.

The voice output controller may perform an operation corresponding to the identified input button if it is determined that the identified input button and a previous identified input button are identical.

The controller may output guidance information for the performance of the operation.

The display device further may include an image processor which processes an image; and a display which displays the image thereon, wherein the voice output controller provides explanation information corresponding to the image that is displayed on the display.

The voice output controller may perform an operation corresponding to the identified input button if it is determined that the identified input button has been input within a predetermined time from the previous identified input button.

The voice output controller may receive the remote control signal as a received remote control signal from the remote controller, where the signal identifies one of the plurality of input buttons of the remote controller that has been selected from the input buttons based on the received remote control signal, selects at least one of a plurality of voice information provided corresponding to the identified input button, and stores the selected voice information in the storage corresponding to the identified input button.

The voice output controller may receive the remote control signal with respect to one of the plurality of input buttons of the remote controller that has been selected from the input buttons, and stores voice information as a voice of a user including at least one of name information, function information and operation information of the input button that has been selected.

If the remote control signal includes a button signal of a button that adjusts a voice level, the voice output controller may output the voice information at a voice level corresponding to the remote control signal.

The voice output controller may provide a plurality of voice levels to adjust a voice level of the voice information, and if one of the plurality of input buttons of the remote controller is input, the voice output controller adjusts the voice level of the voice information into the voice level that has been input and provided.

The foregoing and/or other aspects may be achieved by providing a control method of a display device, the control method including: receiving a remote control signal from a remote controller where the remote controller where the remote controller includes a plurality of input buttons; identifying one of the plurality of input buttons of the remote controller that has been selected from the input buttons as an identified button, based on the received remote control signal; and outputting stored voice information corresponding to the identified input button.

The voice information may include at least one of name information, function information and operation information of respective buttons of the remote controller.

The control method further may include: performing an operation corresponding to the identified input button if it is determined that the identified input button and a previous input button are identical.

The performing the operation may include outputting guidance information for performance of the operation.

The outputting the guidance information include providing explanation information corresponding to an image that is displayed on a display.

The performing the operation may include performing the operation corresponding to the identified input button if it is determined that the identified input button has been input within a predetermined time from the previous input button.

The receiving the remote control signal from the remote controller further may include identifying one of the plurality of input buttons of the remote controller that has been selected from the input buttons, based on the received remote control signal; selecting at least one of a plurality of voice information that is provided corresponding to the identified input button; and storing the voice information selected corresponding to the identified input button.

The control method further may include: receiving the remote control signal corresponding to the one of the plurality of input buttons of the remote controller that has been selected from the input buttons; and storing voice information as a voice of a user which includes at least one of name information, function information and operation information of a selected input button.

The outputting the voice information may include outputting the voice information at a voice level corresponding to the remote control signal if the remote control signal is a signal of a button for adjusting the voice level.

The control method further may include: providing a plurality of voice levels to adjust a voice level of the voice information; inputting one of the plurality of input buttons of the remote controller; and adjusting the voice level of the voice information to the voice level that has been input and provided.

The foregoing and/or other aspects may be achieved by providing a control method of a display device, the control method including: receiving a remote control signal from a remote controller designating one of plural input buttons of the remote controller; and outputting voice information corresponding to the one of the plural input buttons. The voice information may audibly describe a function of the one of the plural input buttons, where the voice information audibly describes a function of the one of the plural input buttons that can be heard by a visually impaired user. The method may also include receiving the remote control signal from the remote controller designating the one of the plural input buttons a second time; and performing the function if the receiving the second time is within a predetermine time period from a first time of the receiving the remote control signal from the remote controller designating the one of the plural input buttons. The method may further include automatically setting a level of the voice information up at predetermined intervals until a second remote control signal from the remote controller designating the one of plural input buttons of the remote controller is received.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates an example of outputting voice information by a display device if a button of a remote controller is pushed;

FIG. 2 is a block diagram of a display device according to an embodiment;

FIG. 3 is a block diagram of a display device according to another embodiment; and

FIGS. 4 to 7 are control flowcharts showing operations of the display device according to the embodiment.

### DETAILED DESCRIPTION OF THE PREFERRED EMBODIMENTS

Below, exemplary embodiments will be described in detail with reference to accompanying drawings so as to be easily realized by a person having ordinary knowledge or skill in the art. The exemplary embodiments may be embodied in various forms without being limited to the exemplary embodiments set forth herein. Descriptions of well-known parts are omitted for clarity, and like reference numerals refer to like elements throughout.

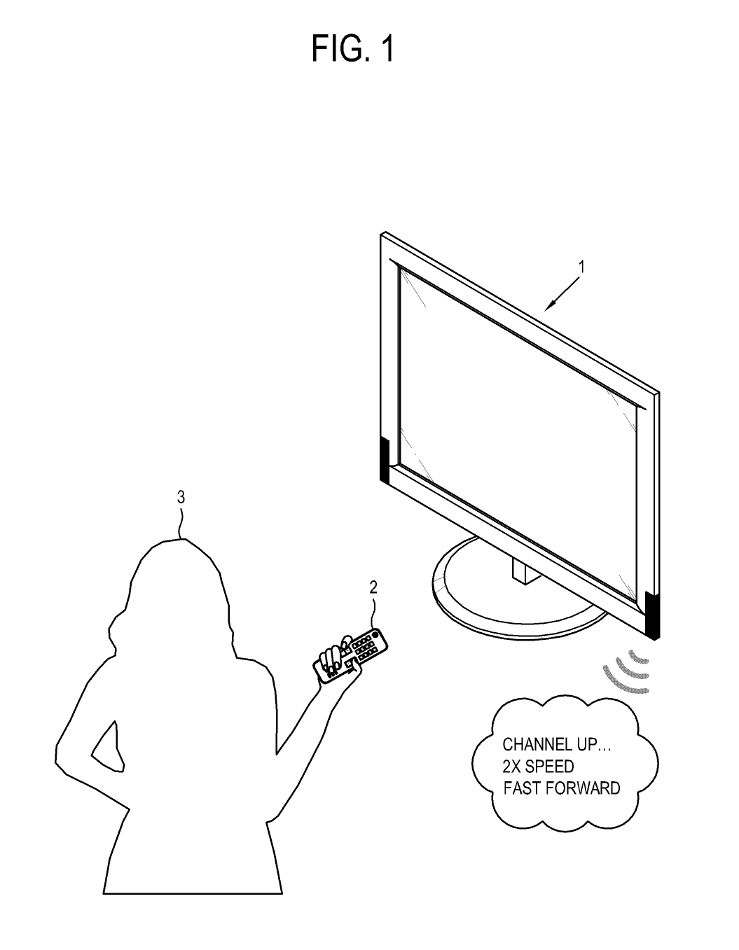

FIG. 1 illustrates an example of outputting voice information by a display device 1 if a button of a remote controller 2 is pushed.

If a user is not visually handicapped, he/she may visually find a button from the remote controller 2 for a desired operation of the display device 1 and make the display device 1 perform the desired operation. However, even if a user is not visually handicapped, there may be buttons of the remote controller 2, the purpose of use of which is not known by a user. In such case, any user including a visually handicapped user would desire to obtain information of the button of the remote controller 2 without difficulty and desire to operate the display device 1.

As shown in FIG. 1, the display device 1 according to an embodiment identifies one of a plurality of input buttons of the remote controller 2 that has been selected by a user from the input buttons based on a received remote control signal and outputs voice information stored therein corresponding to the identified input button if a user 3 pushes the button of the remote controller 2. FIG. 1 illustrates the case where the user 3 pushes a button “channel-up” from the remote controller 2, and corresponding thereto the display device 1 outputs an audible voice regarding name information of the button “channel-up” of the remote controller 2, that is, the device 1 produces speech that speaks “channel up”.

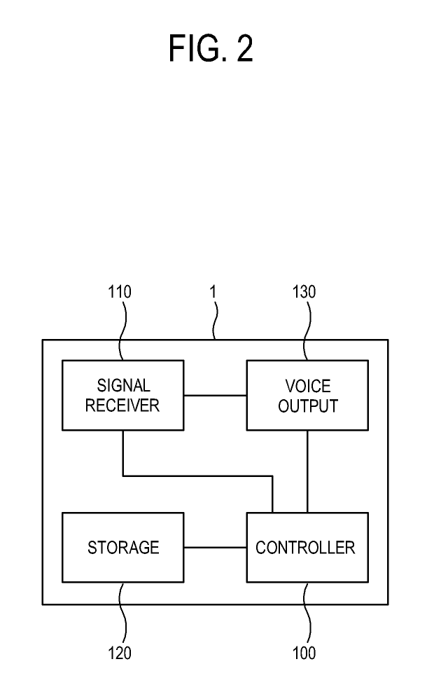

FIG. 2 is a block diagram of the display device 1 according to the embodiment. The display device 1 according to the embodiment may be implemented as a smart TV, a laptop computer or another type of computer. The display device 1 according to the embodiment may include a signal receiver 110, a storage 120, a voice output 130 and a controller 100.

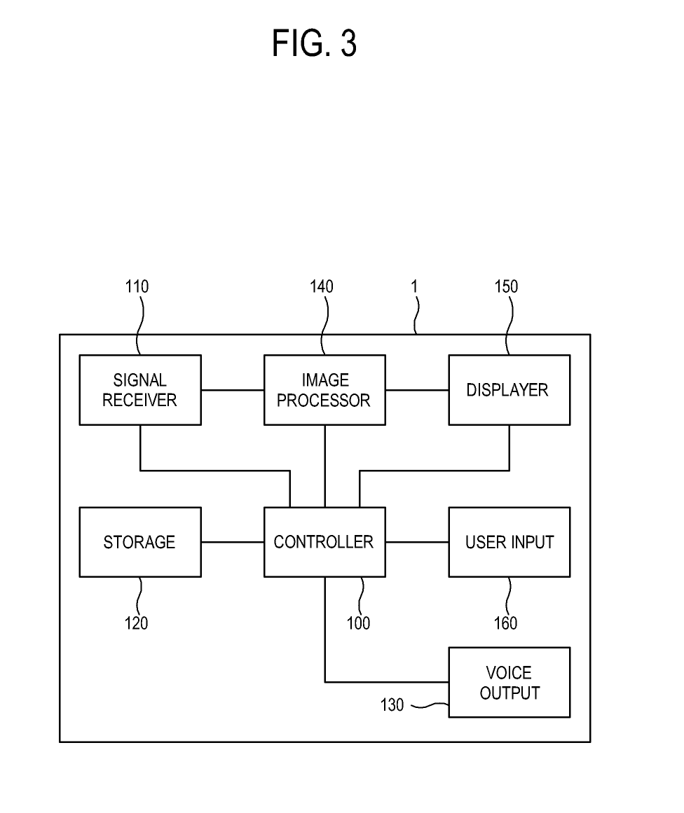

The signal receiver 110 may receive image signals/image data in a wired or wireless manner and transmit the image signals/image data to an image processor 140 (see FIG. 3). The signal receiver 110 may receive broadcast signals including TV broadcast signals as image signals from a broadcast signal transmission device (not shown), receive image signals from imaging devices, such as a digital versatile disc (DVD) player or a blue-ray disc (BD) player, receive image signals from a personal computer (PC), receive image signals from a mobile device, such as a smart phone or a smart pad, receive image signals through a network, such as the Internet or receive image contents as image signals stored in a storage medium, such as a universal serial bus (USB) memory stick. In another embodiment, image signals may be stored in advance in the storage 120 rather than received through the signal receiver 110. The signal receiver 110 may vary depending on a standard of a received image signal and an embodiment type of the display device 1. For example, the signal receiver 110 may receive radio frequency (RF) signals, or receive image signals according to standards such as composite video, component video, super video, SCART (Syndicat des Constructeurs d'Appareils Radiorécepteurs etTéléviseurs—Radio and Television Receiver Manufacturers' Association), high definition multimedia interface (HDMI), DisplayPort, unified display interface (UDI) or wireless HD. If an image signal includes a broadcasting signal, the signal receiver 110 may include a tuner to tune the broadcasting signal per channel.

The signal receiver 110 may transmit various preset control commands or information to the controller 100 by manipulation and input by the user 3. The signal receiver 110 may be implemented as a menu key or an input panel that is installed in an external side of the display device 1, or as a remote controller that is separated/spaced apart from the display device 1. Otherwise, the signal receiver 110 may be integrally formed in the display or displayer 150. If the displayer 150 is a touch screen, the user 3 may touch an input menu (not shown) displayed by the displayer 150 to transmit a preset command to the controller 100.

The signal receiver 110 may receive a motion and voice of the user 3. The motion of the user 3 may include a touch input. The signal receiver 110 may directly receive a motion and voice from the user 3, or receive information of a motion and voice of the user 3 from an external device.

The storage 120 may include a writable ROM (read only memory) in which data remain even upon cutoff of power to the display device 1, and any change may be reflected in respect of a user. That is, the storage 120 may be implemented as one of a flash memory, an erasable programmable read only memory (EPROM) and an electrically erasable programmable read only memory (EEPROM). The storage 120 may store therein audible voice information corresponding to a plurality of input buttons of the remote controller 2. The storage 120 may store therein voice information set by a manufacturer, and voice information set by the user 3. Also, the storage 120 may store therein amended voice information.

The voice output 130 outputs an audible voice which notifies the user 3 of the voice information stored in the storage 120. The voice output 130 may be implemented as a speaker to output a voice. The voice output 130 may output a voice corresponding to an image that is displayed by the display device 1, and the image signal may include voice data when the image signal is processed by the image processor 140. Thus, the voice data included in the image signal may be processed by the image processor 140. The voice output 130 may output the voice that has been processed by the image processor 140.

The controller 100 may identify one of the plurality of input buttons of the remote controller 2 that has been selected from the input buttons based on a received remote control signal, and may control the voice output 130 to output stored audible voice information corresponding to the identified input button.

FIG. 3 is a block diagram of a display device 1 according to another embodiment. The display device 1 according to the another embodiment may include the elements in FIG. 2, and may further include an image processor 140, a displayer or display 150 and a user input 160. The display device 1 according to the another embodiment may further include a voice processor (not shown) to process a voice.

The type of the image processing process performed by the image processor 140 may include, without limitation, de-multiplexing for dividing a predetermined signal into signals by nature; decoding corresponding to an image format of image signals; de-interlacing for converting interlace image signals into progressive image signals; noise reduction for improving image quality; detail enhancement; frame refresh rate conversion, etc. The image processor 140 may include a decoder (not shown) to decode a source image corresponding to an image format of an encoded source image, and a frame buffer (not shown) to store therein a decoded source image per frame.

The image processor 140 may be implemented as a system-on-chip (SoC) which integrates the aforementioned functions or as an image processing board (not shown) that is formed by installing independent elements performing the aforementioned processes in a printed circuit board (PCB) to be installed in the display device 1.

The image processor 140 processes a broadcast signal including an image signal transmitted by the signal receiver 110, and a source image including an image signal supplied by an image supply source (not shown). The image processor 140 may output the processed image signal to the display device 1, so that the display device 1 may display a processed source image.

The displayer 150 may display an image thereon based on an image signal output by the image processor 140. The displayer or display 150 may be implemented as various types of displays including, without limitation, liquid crystal, plasma, light-emitting diode, organic light-emitting diode, surface-conduction electron-emitter, carbon nano-tube, and nano-crystal.

The displayer 150 may further include additional elements depending on its embodiment type. For example, the displayer 150 as a liquid crystal display, may include a liquid crystal display (LCD) panel (not shown), a backlight unit (not shown) emitting light to the LCD panel and a panel driving substrate (not shown) driving the LCD panel.

The displayer 150 displays an image thereon based on an image signal processed by the image processor 140. The displayer 150 employs LCD, PDP, OLED, etc. to display an image thereon. In this case, the displayer 150 may include an LCD panel, a PDP panel or an OLED panel.

The user input 160 may transmit preset various control commands or information to the controller 100 by a manipulation and input by the user 3. The user input 160 is implemented as a menu key or an input panel that is installed in an external side of the display device 1, or as a remote controller that is separated/spaced apart from the display device 1. Otherwise, the user input 160 may be integrally formed in the displayer 150. If the displayer 150 is a touch screen, the user 3 may touch an input menu (not shown) displayed by the displayer 150 to transmit a preset command to the controller 100.

The user input 160 may receive a motion and voice of the user 3. The motion of the user 3 may include a touch input. The user input 160 may directly receive a motion and voice from the user 3, or receive information of a motion and voice of the user 3 from an external device. The user input 160 may be included in the signal receiver 110.

A voice processor (not shown) may perform processes with respect to a voice/sound that is input to the voice processor, out of various preset processes performed by the display device 1. The “voice” processed by the voice processor means a voice input to the voice processor. An image signal processed by the image processor 140 may include voice data, and the voice data included in the image signal may be processed by the image processor 140.

If a voice/sound is input to the voice processor, the voice processor determines whether the input voice/sound has been spoken by the user 3 or has been generated by other causes. Such determination method may employ various configurations and thus may not be specified. For example, the determination method may include determining whether an input voice/sound corresponds to a wavelength/frequency bands corresponding to a human voice, or determining whether an input voice/sound corresponds to a voice profile of the user 3 that is designated in advance.

If it is determined that the input voice/sound has been spoken by the user 3, the voice processor performs a preset corresponding operation according to a voice command that corresponds to the speaking. The voice command means the content spoken by the user 3. The voice input part that has been referred to regarding the voice processor may be configured together with the voice output 130 in FIG. 1. The voice input part and the voice output 130 may collect and output a voice like a speaker, and may preferably be implemented as a speaker which may simultaneously collect and output a voice.

The controller 100 may output voice information including at least one of name information, function information and operation information of a plurality of input buttons of the remote controller 2. The function information may include explanation of functions of the buttons of the remote controller 2. The operation information may include operational information of the display device 1 that is operated by the buttons of the remote controller 2.

If it is determined that the identified input button and the previous input button are identical, the controller 100 may perform an operation corresponding to the identified input button. If the identified input button and the button that has been previous input by the user 3 are identical, the controller 100 controls the display device 1 to perform an operation corresponding to the input button. If the identified input button and the button that has been previous input by the user 3 are not identical, the controller 100 may output voice information, i.e., at least one of name information, function information and operation information corresponding to the most recent input button.

The controller 100 may output guidance information of a performance of an operation. If the identified input button and the button that has been previously input by the user 3 are identical, the controller 100 performs an operation corresponding to the input button. Even though an operation such as “channel-up” may be performed by increasing channels, other buttons such as an input button for adjusting a playing speed of images need an operation of outputting guidance information for the operation. For example, guidance information such as a playing point, a playing rate and a playing speed may be spoken to the user 3.

The controller 100 may provide explanation information corresponding to an image displayed on the displayer 150. If an image is displayed on the displayer 150, the user 3 who is not visually handicapped may recognize information of the image by just viewing the image. However, the visually handicapped user 3 may recognize the image only when the explanation of the image is spoken. Thus, the controller 100 may provide the user 3 with an audible voice of the explanation information, separately from and jointly with a voice included in the image.

If it is determined that the identified input button has been input within a predetermined time from the previous input button, the controller 100 may perform an operation corresponding to the identified input button. For example, if the user 3 has used the “channel-up” button of the remote controller 2 to watch news before he/she leaves for work. After coming back home from work, the user 3 may push the “channel-up” button again. In this case, since a predetermined time or more has elapsed, the channel is not increased but the controller 100 provides voice information corresponding to the “channel-up” button if the “channel-up” button is pushed by the user 3. Therefore, if the same input button is pushed within a predetermined time from the previous input button, the controller 100 performs the corresponding operation, in this example the channel-up operation.

The controller 100 may receive a remote control signal from the remote controller 2 including a plurality of input buttons, may identify one of the plurality of input buttons that has been selected from the input buttons, based on the received remote control signal, may select at least one of a plurality of voice information that is provided corresponding to the identified input button, and may store the selected voice information in the storage 120 corresponding to the identified input button. Therefore, the user 3 may be provided with desired voice information corresponding to the input button of the remote controller 2.

The controller 100 may receive a remote control signal with respect to one of the plurality of input buttons of the remote controller 2 that has been selected from the input buttons, and may store voice information as a voice of the user 3 which includes at least one of name information, function information and operation information of the selected input button. The user 3 may input voice information corresponding to the input button of the remote controller 2 with his/her voice rather than selecting the plurality of voice information provided, and may be provided with his/her voice information when he/she later pushes the same input button of the remote controller 2.

If the remote control signal is a signal of a button for adjusting a voice level, the controller 100 may output voice information at a voice level that corresponds to the remote control signal. If the user 3 is visually handicapped, the controller 100 may provide voice information as well as increasing a volume when the user 3 pushes an input button of the remote controller 2 for increasing volume. The controller 100 may perform corresponding operations with respect to all of the buttons of the remote controller 2 as well as the button for adjusting the voice level.

The controller 100 provides a plurality of voice levels to adjust a voice level of voice information, and if one of the plurality of input buttons of the remote controller 2 is input, the controller 100 may adjust the voice level of the voice information to the voice level that has been input and provided. The controller 100 may provide guidance information for adjusting a voice level of voice information when a predetermined button of the remote controller 2 is input, when the display device 1 is turned on or off and before or after voice information is provided, and the user 3 may adjust the voice level by selecting the provided voice level.

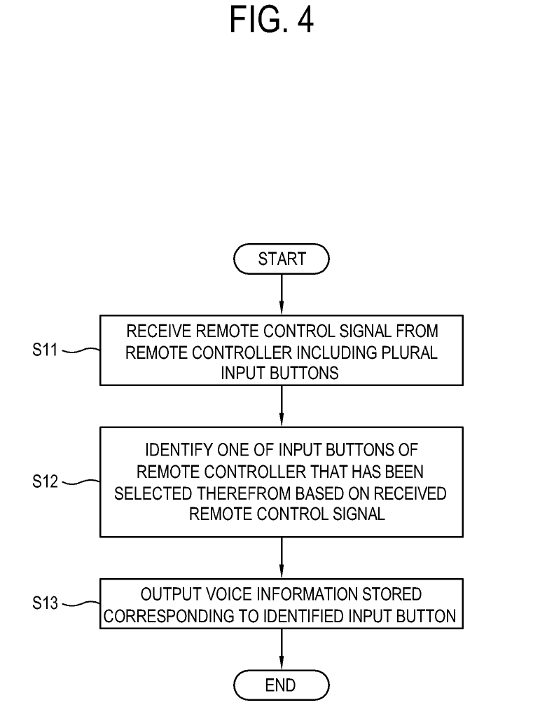

FIG. 4 is a control flowchart showing operations of the display device 1 according to the embodiment.

The display device 1 receives the remote control signal from the remote controller 2 including the plurality of input buttons (S11).

The controller 100 identifies one of the plurality of input buttons of the remote controller 2 that has been selected from the input buttons, based on the received remote control signal (S12).

The controller 100 outputs the stored voice information corresponding to the identified input button (S13).

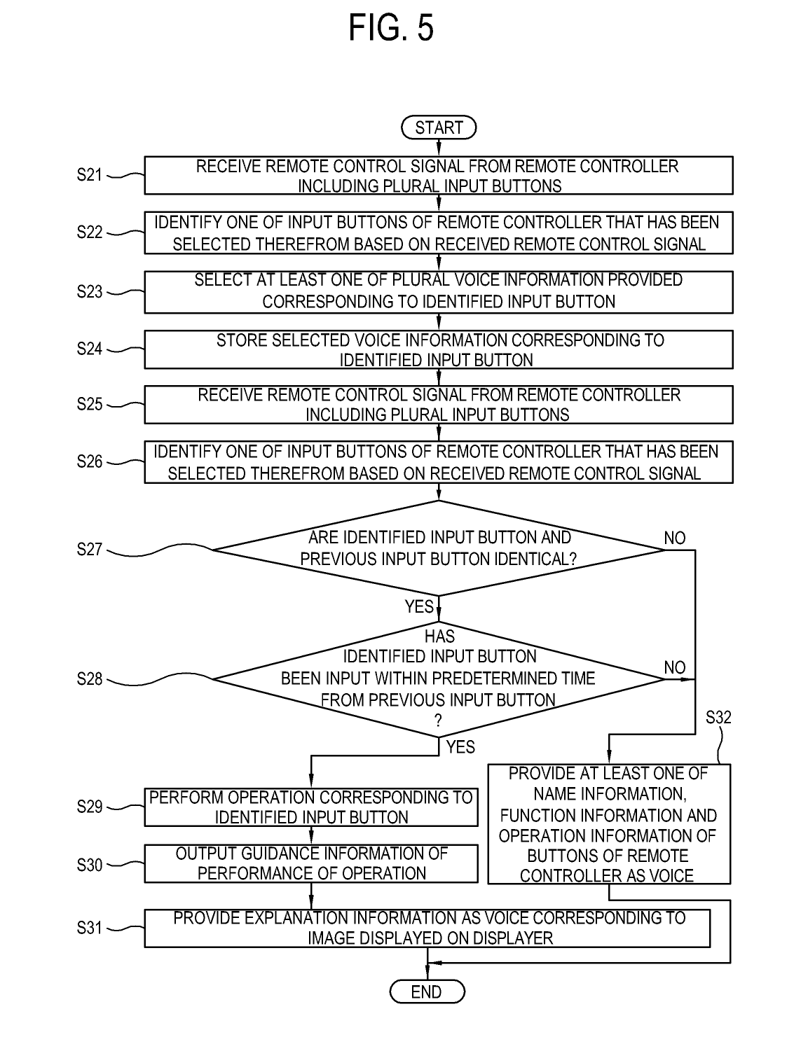

FIG. 5 is a control flowchart showing operations of the display device 1 according to the embodiment.

The display device 1 receives the remote control signal from the remote controller 2 including the plurality of input buttons (S21).

The controller 100 identifies one of the plurality of input buttons of the remote controller 2 that has been selected from the input buttons, based on the received remote control signal (S22).

The controller 100 provides the plurality of voice information corresponding to the identified input button. The user 3 selects at least one of the plurality of voice information (S23).

The controller 100 stores the selected voice information corresponding to the identified input button (S24).

The display device 1 receives the remote control signal from the remote controller 2 including the plurality of input buttons (S25).

The controller 100 identifies one of the plurality of input buttons of the remote controller 2 that has been selected from the input buttons, based on the received remote control signal (S26).

The controller 100 determines whether the identified input button and the previous input button selected are identical (S27).

If yes, the controller 100 determines whether the identified input button has been input within the predetermined time from the previous input button (S28).

If it is determined that the identified input button has been input within the predetermined time from the previous input button, the controller 100 performs the operation corresponding to the identified input button (S29). For example, if the user 3 pushes the channel-up button and listens to the voice information and immediately pushes the channel-up button again, the channel is increased from the current channel. The operation S28 may be skipped and the operation of the display device 1 may be performed.

Then, the guidance information of the performance of the operation is output (S30). The buttons of the remote controller 2 may be classified into buttons for outputting guidance information and buttons for performing operations. For example, guidance information may not be output with respect to an input of buttons such as channel-up, channel-down, volume-up, and volume-down, and guidance information such as “2× speed fast forward is being performed” may be output for an input button for adjusting the playing speed of images.

Then, explanation information may be provided as a voice (or audibly) corresponding to an image displayed on the displayer 150 (S31). If the image is displayed on the displayer 150, explanation information which explains an operation of the image, circumstances and developments may be provided as a voice. The explanation information may be provided to the user 3, separately from or jointly with the voice related to the image such as lines corresponding to the image.

If it is determined at operation S27 that the identified input button and the previous input button are not identical, and if it is determined at operation S28 that the identified input button has not been input within the predetermined time from the previous input button, the controller 100 provides at least one of name information, function information and operation information of the respective buttons of the remote controller 2 as a voice or audibly (S32). The predetermined time may be set by a manufacturer or the user 3, and may be approximately 5 seconds after the input button is pushed and the voice information is output.

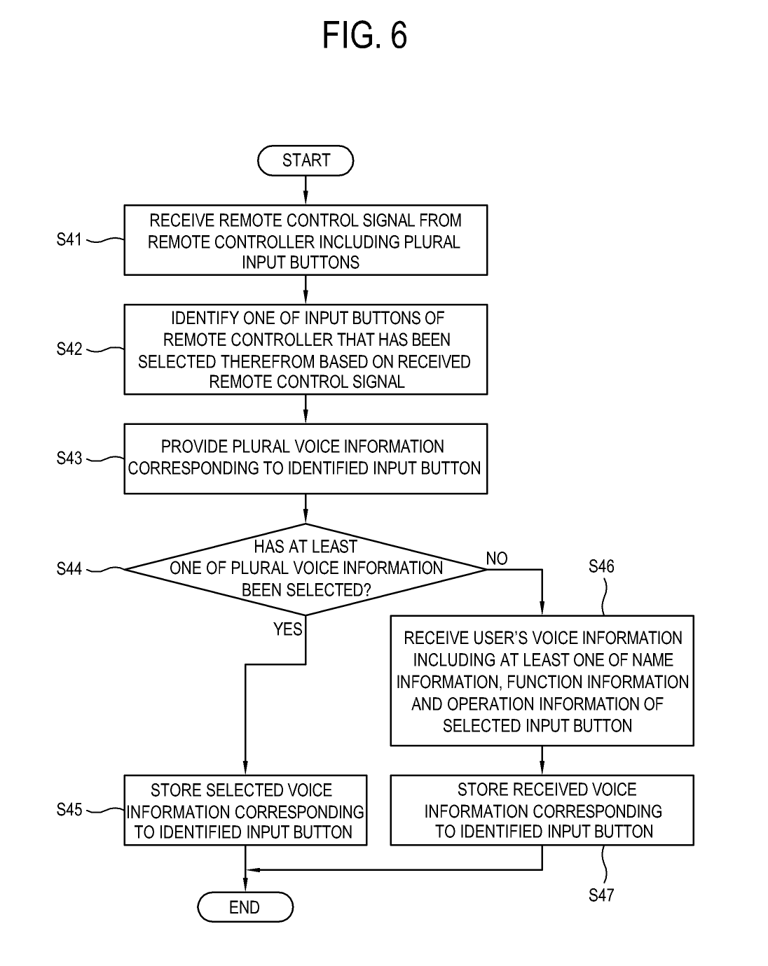

FIG. 6 is a control flowchart showing operations of the display device 1 according to the embodiment.

More specifically, FIG. 6 is a control flowchart showing operations for storing the voice information by using the display device 1 by the user 3 according to the embodiment.

The display device 1 receives the remote control signal from the remote controller 2 including the plurality of input buttons (S41).

The controller 100 identifies one of the plurality of input buttons of the remote controller 2 that has been selected from the input buttons, based on the received remote control signal (S42).

The controller 100 provides the plurality of voice information corresponding to the identified input button (S43). The plurality of voice information may include various types of voice information that are provided with respect to a single button of the remote controller 2. For example, the channel-up button may have various voice information so that a user may select desired voice information such as languages, dialects and different names.

The user 3 determines whether at least one of the plurality of voice information has been selected (S44). The method of selecting at least one of the plurality of voice information includes selection of voice information by selecting any of the plurality of buttons of the remote controller 2 after the user 3 listens to desired voice information. The plurality of provided voice information may include the provision of an example of single voice information and then give the user 3 the opportunity to select the voice information by providing the user 3 with the voice regarding the selection or non-selection of the provided voice information.

If the user 3 has selected the voice information at operation S44, the controller 100 stores the selected voice information corresponding to the identified input button (S45).

If the user 3 has not selected the voice information at operation S44, the controller 100 receives the voice information of the user 3 including at least one of the name information, function information and operation information of the input button that has been selected at operation S42 (S46). The user 3 has recognized the input button of the remote controller 2 that has been pushed by the user 3, based on the plurality of voice information provided to the user 3, and may record a voice or speech with respect to desired name, function and operation. For example, if the user 3 does not select one of the plurality of provided voice information, the user 3 may be provided with guidance information on whether to record and store his/her voice or speech, and may record his/her voice according to the guidance.

Then, the controller 100 stores the received voice information corresponding to the identified input button of the remote controller 2 (S47). The controller 100 may process the received voice, generate a voice profile corresponding to the input button of the remote controller 2 and store the voice profile in the storage 120.

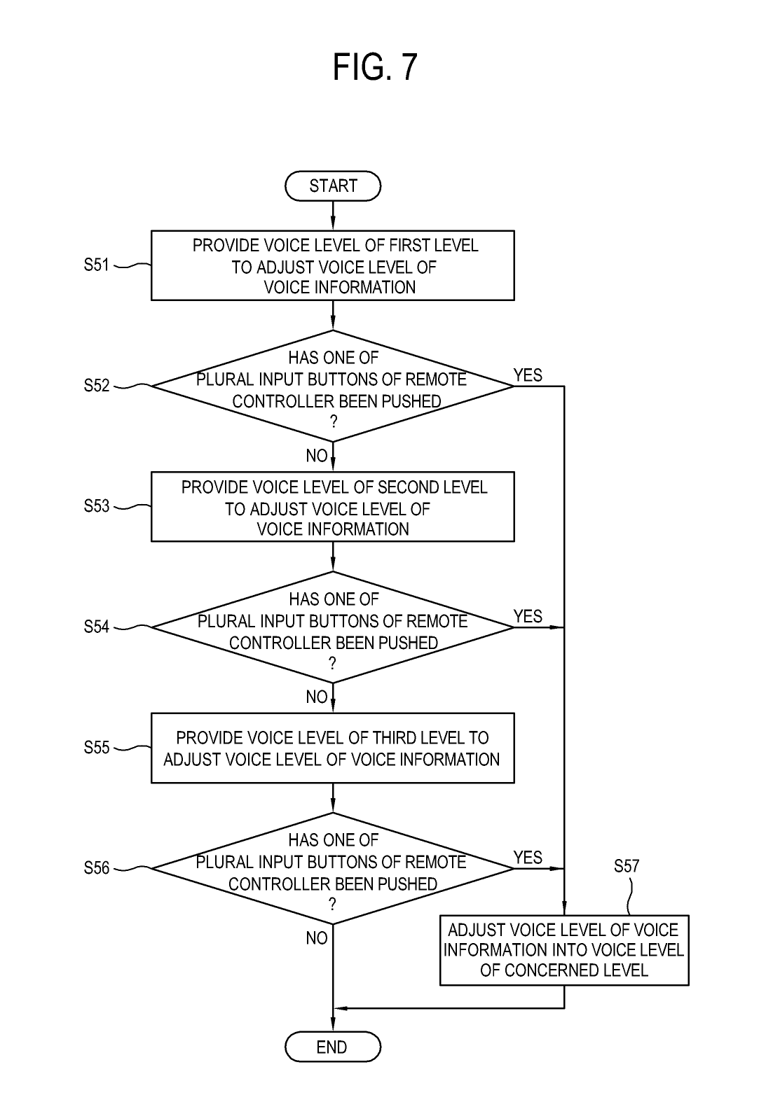

FIG. 7 is a control flowchart showing operations of the display device 1 according to the embodiment.

The controller 100 may provide guidance information for adjusting the voice information at the time when a predetermined button of the remote controller 2 is input, when the display device 1 is turned on or off and before or after the voice information is provided. FIG. 7 is a control flowchart showing the operation for adjusting the voice information.

The controller 100 provides a voice level of a first level to adjust the voice level of the voice information (S51). The user 3 may be provided with the guidance information on whether he/she will select the first voice level. If the user 3 selects the first voice level, he/she may be guided to push any of the input buttons of the remote controller 2.

The controller 100 identifies whether one of the plurality of input buttons of the remote controller 2 has been input (S52). This is to identify whether any of the input buttons of the remote controller 2 has been input.

If any of the input buttons has been input, the controller 100 adjusts the voice level to the first voice level (S57).

The operations S51 and S52 are repeated with respect to a second voice level and a third voice level (S53 to S56). However, if the user 3 decides the voice level is acceptable and pushes the input button of the remote controller 2, the controller 100 adjusts the voice level to the voice level decided by the user 3, and stores the voice level (S57).

The display device 1 may identify the input button of the remote controller 2 pushed by the user 3 who is visually handicapped, and may provide the voice information of the pushed input button. Thus, even a visually handicapped user may freely and conveniently manipulate the display device 1.

As described above, a display device and a control method thereof according to embodiments may store voice information corresponding to a plurality of input buttons of a remote controller, may identify one of the plurality of input buttons that has been selected from the input buttons, based on a received remote control signal and may output the stored voice information corresponding to the identified input button. Thus, even a visually handicapped user may freely and conveniently manipulate the display device with a remote controller.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated hardware-based computer or processor unique to that unit or by a hardware-based computer or processor common to one or more of the modules. The described methods may be executed on a general purpose computer or processor or may be executed on a particular machine such as the encoding apparatus and decoding apparatus described herein.

Although a few exemplary embodiments have been shown and described, it will be appreciated by those skilled in the art that changes may be made in these exemplary embodiments without departing from the principles and spirit of the embodiments, the range of which is defined in the appended claims and their equivalents.

What is claimed is:

1. A display device, comprising:
a signal receiver which receives a remote control signal from a remote controller where the remote controller comprises a plurality of input buttons;
a storage which stores therein voice information corresponding to the plurality of input buttons of the remote controller;
a voice output which outputs the voice information; and
a voice output controller which identifies one of the plurality of input buttons that has been selected from the input buttons as an identified input button based on the remote control signal that has been received, and controls the voice output to output the voice information that has been stored corresponding to the identified input button.

2. The display device according to claim 1, wherein the voice information comprises at least one of name information, function information and operation information of the plurality of input buttons of the remote controller.

3. The display device according to claim 1, wherein the voice output controller performs an operation corresponding to the identified input button if it is determined that the identified input button and a previous identified input button are identical.

4. The display device according to claim 3, wherein the controller outputs guidance information for the performance of the operation.

5. The display device according to claim 3, further comprising:
an image processor which processes an image; and
a display which displays the image thereon,
wherein the voice output controller provides explanation information corresponding to the image that is displayed on the display.

6. The display device according to claim 3, wherein the voice output controller performs an operation corresponding to the identified input button if it is determined that the identified input button has been input within a predetermined time from the previous identified input button.

7. The display device according to claim 1, wherein the voice output controller receives the remote control signal as a received remote control signal from the remote controller, identifies one of the plurality of input buttons of the remote controller that has been selected from the input buttons based on the received remote control signal, selects at least one of a plurality of voice information provided corresponding to the identified input button, and stores the selected voice information in the storage corresponding to the identified input button.

8. The display device according to claim 1, wherein the voice output controller receives the remote control signal with respect to one of the plurality of input buttons of the remote controller that has been selected from the input buttons, and stores voice information as a voice of a user comprising at least one of name information, function information and operation information of the input button that has been selected.

9. The display device according to claim 1, wherein if the remote control signal comprises a button signal of a button that adjusts a voice level, the voice output controller outputs the voice information at a voice level corresponding to the remote control signal.

10. The display device according to claim 1, wherein the voice output controller provides a plurality of voice levels to adjust a voice level of the voice information, and if one of the plurality of input buttons of the remote controller is input, the voice output controller adjusts the voice level of the voice information to the voice level that has been input and provided.

11. A control method of a display device, the control method comprising:
receiving a remote control signal from a remote controller where the remote controller comprises a plurality of input buttons;
identifying one of the plurality of input buttons of the remote controller that has been selected from the input buttons as an identified button, based on the received remote control signal; and
outputting stored voice information corresponding to the identified input button.

12. The control method according to claim 11, wherein the voice information comprises at least one of name information, function information and operation information of respective buttons of the remote controller.

13. The control method according to claim 11, further comprising:
performing an operation corresponding to the identified input button if it is determined that the identified input button and a previous input button are identical.

14. The control method according to claim 13, wherein the performing the operation comprises outputting guidance information for performance of the operation.

15. The control method according to claim 13, wherein the outputting the guidance information comprises providing explanation information corresponding to an image that is displayed on a display.

16. The control method according to claim 13, wherein the performing the operation comprises performing the operation corresponding to the identified input button if it is determined that the identified input button has been input within a predetermined time from the previous input button.

17. The control method according to claim 11, wherein the receiving the remote control signal from the remote controller further comprises:
identifying one of the plurality of input buttons of the remote controller that has been selected from the input buttons, based on the received remote control signal;
selecting at least one of a plurality of voice information that is provided corresponding to the identified input button; and
storing the voice information selected corresponding to the identified input button.

18. The control method according to claim 11, further comprising:
receiving the remote control signal corresponding to the one of the plurality of input buttons of the remote controller that has been selected from the input buttons; and
storing voice information as a voice of a user which comprises at least one of name information, function information and operation information of a selected input button.

19. The control method according to claim 11, wherein the outputting the voice information comprises outputting the voice information at a voice level corresponding to the remote control signal if the remote control signal is a signal of a button for adjusting the voice level.

20. The control method according to claim 11, further comprising:
providing a plurality of voice levels to adjust a voice level of the voice information;
inputting one of the plurality of input buttons of the remote controller; and
adjusting the voice level of the voice information to the voice level that has been input and provided.
